(19) United States
(12) Patent Application Publication
(10) Pub. No.: US 2009/0125555 A1
(43) Pub. Date: May 14, 2009

(54) METHOD AND APPARATUS FOR FLEXIBLE ARCHIVING

(75) Inventors: Marc Stanis, Wheaton, IL (US); Seshadri Sekharan Davarapalli, Algonquin, IL (US); Shrikant Deshpande, Glendale Heights, IL (US); Jeff Chu, Buffalo Grove, IL (US); Robert Grant, West Dundee, IL (US); Udaya Kumar KV, Amadalavalasa (IN)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/940,140

(22) Filed: Nov. 14, 2007

(51) Int. Cl. G06F 17/30

(52) U.S. Cl. 707/104.1; 707/E17.019

(57) ABSTRACT

Certain embodiments of the present invention provide a system and method for selectively archiving medical imaging data. The method comprises receiving criteria to selectively archive medical imaging data. The criteria may include but is not limited to, for example, one of the following: modality, procedure code, institution, department, physician, data type, patient demographics. The method may also include acquiring medical imaging data. The medical imaging data may have associated information, for example header information or image data. The method may also include comparing the associated information with the criteria. The medical images having associated information that satisfies the criteria is archived and the medical images having associated information that does not satisfy the criteria is discarded.

### BACKGROUND OF THE INVENTION

The present invention generally relates to a system and method for archiving radiology exams. Particularly, the present invention relates to selectively archiving data in a healthcare context.

Medical diagnostic imaging systems encompass a variety of imaging modalities, such as x-ray systems, computerized tomography (CT) systems, ultrasound systems, electron beam tomography (EBT) systems, magnetic resonance (MR) systems, and the like. Medical diagnostic imaging systems generate images of an object, such as a patient, for example, through exposure to an energy source, such as x-rays passing through a patient, for example. The generated images may be used for many purposes. For instance, internal defects in an object may be detected. Additionally, changes in internal structure or alignment may be determined. Fluid flow within an object may also be represented. Furthermore, the image may show the presence or absence of objects in an object. The information gained from medical diagnostic imaging has applications in many fields, including medicine and manufacturing.

As medical diagnostic imaging technology has advanced, the amount of data a medical diagnostic imaging system may produce has increased. For example, ten years ago the average CT exam contained approximately 70-80 slices. Typical current CT exams may now exceed 1000 slices. New scanning technologies have the potential to exceed multi-thousand slice scans. Medical diagnostic imaging systems have traditionally archived every image. As the amount of data increases and the number of slices increase, it may not be desirable to archive all acquired data. Generally, it is also not desirable to manually select which data to archive and which data to discard.

### SUMMARY OF THE INVENTION

Certain embodiments of the present invention provide a system and method for selectively archiving medical imaging data. In an embodiment, the system is a picture archival communication system. The system includes a display unit for displaying medical images. The medical images have associated information. In an embodiment, the associated information is header information. The header information may be for a plurality of medical images or for a single medical image. The system includes an input unit for receiving input from a user. The input includes criteria to selectively archive the medical images. In an embodiment, the criteria include one of the following: modality, procedure code, institution, department, physician, data type, patient demographics. In an embodiment, the criteria include archiving a plurality of medical images until a more recent set of medical images is acquired for the patient. In an embodiment, the criteria are image data, and the image data may be anatomical structures. In an embodiment, the input from a user includes input regarding manual selection of medical images for archiving. The system includes a computer unit for executing computer software. The computer software compares the associated information with the criteria and archives medical images having associated information that satisfies the criteria.

Certain embodiments of the present invention include a method for selectively archiving medical imaging data. The method includes receiving criteria to selectively archive medical imaging data. The method also includes acquiring medical imaging data. The medical imaging data has associated information. In an embodiment, the associated information is header information. The header information may be for a plurality of medical images for a single medical image. The method also includes comparing the associated information with the criteria. In an embodiment, the criteria include one of the following: modality, procedure code, institution, department, physician, data type, patient demographics. In an embodiment, the criteria are image data. The method also includes archiving medical images having associated information that satisfies the criteria and discarding medical images having associated information that does not satisfy the criteria.

Certain embodiments of the present invention include a computer-readable storage medium including a set of instructions for a computer. The set of instructions include a receipt routine for receiving criteria to selectively archive medical imaging data from a user. The set of instructions include an acquisition routine for acquiring medical imaging data. The medical imaging data has associated information. In an embodiment, the associated information is header information. The set of instructions includes an optional display routine for displaying the medical images represented by the medical imaging data after the medical imaging data is acquired and prior to comparing the associated information with the criteria. The set of instructions includes an optional marking routine for manually marking images for archiving. The set of instructions includes a comparison routine for comparing the associated information with the criteria. The set of instructions also includes an archiving and discarding routine for archiving medical imaging data having associated information that satisfies the criteria and discarding medical imaging data having associated information that does not satisfy the criteria.

### BRIEF DESCRIPTION OF THE DRAWINGS

FIG. 1 illustrates a system in accordance with an embodiment of the present invention.

FIG. 2 illustrates a method in accordance with an embodiment of the present invention.

### DETAILED DESCRIPTION OF THE INVENTION

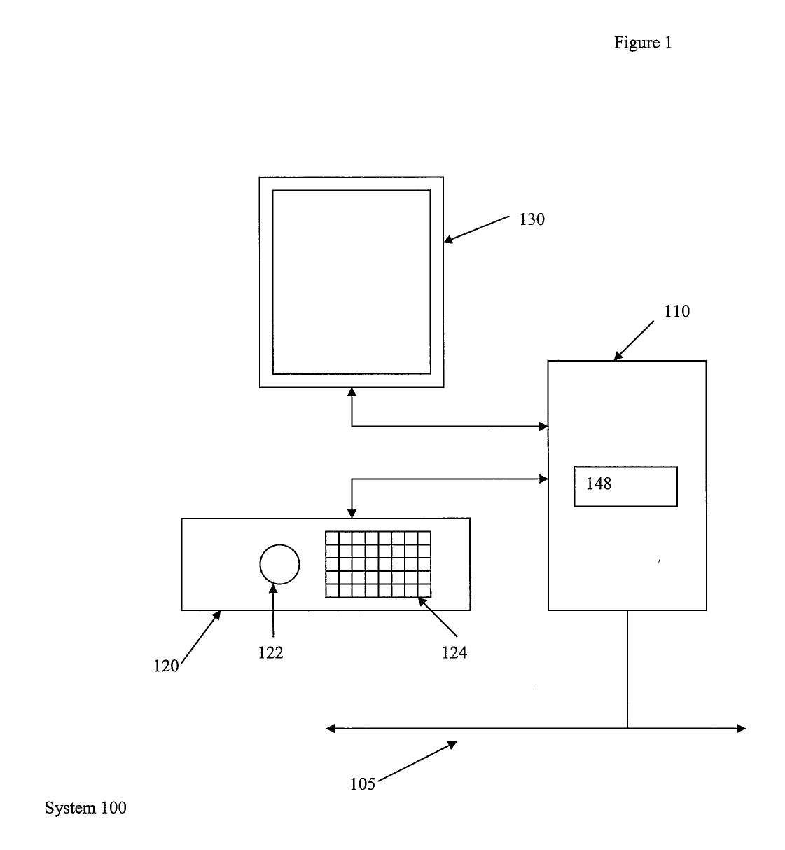

FIG. 1 illustrates a system 100 for reviewing medical images. The system 100 includes a computer unit 110. The computer unit 110 may be any equipment or software that permits electronic medical images, such as x-rays, ultrasound, CT, MRI, gated MRI, EBT, MR, or nuclear medicine for example, to be electronically acquired, stored, or transmitted for viewing and operation. The computer unit 110 may receive input from a user. The computer unit 110 may be connected to other devices as part of an electronic network. In FIG. 1, the connection to the network is represented by line 105. The computer unit 110 may be connected to network 105 physically, by a wire, or through a wireless medium. In an embodiment, the computer unit 110 may be, or may be part of, a picture archival communication system (PACS).

The system 100 also includes an input unit 120. The input unit 120 may be a console having a track ball 122 and keyboard 124. Other input devices may be used to receive input from a user as part of the input unit 120. For example a microphone may be used to receive verbal input from a user. The system 100 also includes at least one display unit 130. The display unit 130 may be a typical computer display unit. The display unit 130 may be in electrical communication with the computer unit 110 and input unit 120. In an embodiment, the display unit 130 may represent multiple display units or display regions of a screen. Accordingly, any number of display units may be utilized in accordance with the present invention.

In an embodiment, the system 100 is a PACS with display unit 130 representing the display unit of PACS. The computer unit 110 may represent equipment and components of a PACS system other than the display unit. The computer unit 110 and display unit 130 may be separate units or be part of a single unit. In the case of separate units, the display unit 130 may be in electrical communication with the computer unit 110. The components of the system 100 may be single units, separate units, may be integrated in various forms, and may be implemented in hardware and/or in software.

In operation, a user or other system may input criteria that are used to determine which images, sets of images, or other data such as SOPs, structured reports, key image notes, or presentation states, are archived. A user may input criteria in conjunction with external system input criteria. For example, external system input may include a HIS/RIS sending a do not archive message. In an embodiment, the computer unit 110 may retrieve a set of medical images. The set of images may have been generated from a medical diagnostic imaging system, such as an x-ray system, a computerized tomography (CT) system, an ultrasound system, an electron beam tomography (EBT) system, or a magnetic resonance (MR) system. It is contemplated that a set of images from other imaging systems may be retrieved. In an embodiment, the computer unit 110 may retrieve the set of images from an external device, such as external memory, a server, or other device, over network 105. In another embodiment, the computer unit 110 may retrieve the set of images from internal memory.

In an embodiment, the computer unit 110 may display the set of images on the display unit 130. A user may manipulate the set of images by using the input unit 120. Once the user is finished with the set of images, the computer software 148 may compare the information associated with the set of images with the criteria to selectively archive the set of images. It is also contemplated that the computer software 148 may compare the information associated with the set of images with the criteria without displaying the set of images on the display unit 130. In an embodiment, the images, or set of images, having associated information satisfying the criteria are archived and the images, or set of images, having associated information that does not satisfy the criteria are discarded. In an embodiment, the computer software 148 is executed by the computer unit 110. It is contemplated the computer software 148 is executed on devices other than the computer unit 110 or over multiple devices. In an embodiment, a user may customize the selection of data for archiving according to the user's context and application. Such a system allows an efficient archiving of data with minimal user intervention.

In an embodiment, the computer software 148 determines which information to archive and which information to discard based on criteria. The criteria may be input by a user or other external system. For example, the computer software 148 may utilize information from an external system such as a HIS/RIS sending a do not archive message. The computer software 148 may utilize information input by a user. For example, the criteria the computer software 148 may utilize may include, but is not limited to, the modality/acquisition device, AE Title, procedure code, institution or organization, department, referring physician/group, data type, such as image, KIN, SR, waveform, trigger event such as a newer related exam is detected, patient demographics such as age or gender, manual marking to archive or discard, or other information. For example, the computer software 148 may review the information associated with a set of images and the information associated with each individual image to determine whether to archive the information or to discard the information based on the criteria selected by the user and any other criteria. In another example, the computer software 148 may review the information associated with other data types, such as SOPs which may include images, structured reports, key image notes, or presentation states, to determine whether to archive the information or discard the information based on the criteria selected by the user and/or criteria input by an external system.

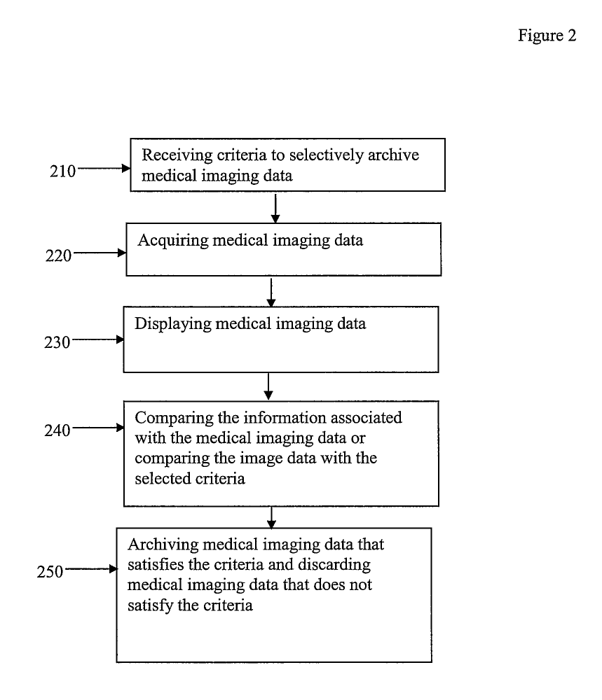

FIG. 2 illustrates an example of a method 200 that may be used in accordance with an embodiment of the present invention. At step 210, the computer software receives the criteria to selectively archive data. In an embodiment, a user may input various criteria depending on the application and context. Additionally, criteria may be retrieved from external systems, for example, a HIS/RIS sending a do not archive message. As discussed above, the criteria may be any factor that can be used to filter images or sets of images. The scope of the possible criteria is not limited to the examples provided herein. For example, a user may determine that only images relating to a certain procedure should be archived. The computer software may identify the procedure with a procedure code and archive data having the procedure code. In another example, a user may determine that the current set of data is discarded once a newer related exam is detected. For example, a first image scan may be discarded upon detection of a second, subsequent image scan for the same patient. In another example, a user may indicate that only CT exams should be archived. Medical images originating from a modality other than CT exams may be discarded. A user may input any number of criteria, including criteria not identified above, to determine which information should be archived. The criteria define archiving rules that are used to archive or discard data. In an embodiment, the criteria may be reset by a user at any time. It is also contemplated that the criteria may be factors used to discard information.

At step 220, medical imaging data is acquired. The medical imaging data may include a set of images and the image's associated information or other types of information such as SOP information, including images, structured reports, key image notes, and presentation states. In an embodiment, the set of images may have been generated from a medical diagnostic imaging system, such as an x-ray system, a computerized tomography (CT) system, an ultrasound system, an electron beam tomography (EBT) system, or a magnetic resonance (MR) system. It is contemplated that a set of images from other imaging systems may be retrieved. It is also contemplated the set of images is retrieved from memory, such as external memory or internal memory. The associated information may be information associated with the set of images or information associated with each individual image. For example, the associated information for a set of images may include information regarding modality, procedure type, data type, patient demographics and identifying information, physician, or other information. The associated information associated with each individual image may include other information that is not common to the entire set of images, for example information describing the contents of an image. For example, the contents of an image may include the anatomical structure illustrated in the image.

At step 230, medical imaging data may be displayed. For example, the medical imaging data may include a set of images. In an embodiment, a user may manipulate the images, for example reviewing various images from the set of images. In an embodiment, a user may manually mark images to be archived while viewing the images. For example, if a user wishes to archive an image, but is not sure whether the archiving rules will select the image, the user may archive the image manually by selecting the image. In an embodiment, the manual selection works in addition to the archiving rules defined by the criteria. Alternatively, the set of images is not displayed. Once a set of images and the image's associated information is acquired at step 220, display of the set of images is not necessary prior to executing step 240.

At step 240, the information associated with the medical imaging data is compared with the criteria received at step 210. In an embodiment, the set of images and the associated information is compared with the criteria received at step 210. Data types other than images may have associated information, such as SOPs, structured reports, key image notes, and presentation states that also may be compared with the criteria received at step 210. For example, the associated information may be header information for the set of images such as procedure code, institution, patient demographics, data type, modality, or other information relevant to the entire set of images. In an embodiment, if the header information for the set of images, or other data type, contains criteria selected for archiving, then step 250 is executed. In an embodiment, if the header information for the set of images does not contain criteria selected for archiving, then header information associated with each individual image is compared to the criteria. In an example, the header information associated with each individual image may be compared with the criteria to determine whether the individual image satisfies the criteria. If the individual image, or other data type, satisfies the criteria, then step 250 is executed. It is contemplated that the set of images and the individual images do not satisfy the criteria. In such a circumstance, step 250 is executed. At step 250, information that satisfies the criteria is archived and information that does not satisfy the criteria is discarded.

In an embodiment, the criteria used to determine whether an image will be archived or discarded may be image data itself. For example, it is contemplated that the image data is processed to identify structure in the images. For example, the image data may be processed to identify anatomical structures, such as images of the lungs, colon, heart, or other anatomical structures. The criteria used to determine whether the set of images or individual images will be archived or discarded may be, for example, to archive all images of the heart, but discard images not containing images of the heart. For example, the criteria may be to archive all images containing images of the lungs, but discard images not containing images of the lungs. It is contemplated that any anatomical structure may be used as criteria for filtering.

The system and method described above may be carried out as part of a computer-readable storage medium including a set of instructions for a computer. The set of instructions may include a receipt routine for receiving selection criteria. The selection criteria may be received from a user or from an external system. For example, a user may input various criteria depending on the application and context. A user may input any number of criteria, including criteria not identified above, to determine which information should be archived. Criteria received from an external system may include, for example, a HIS/RIS sending a do not archive message.

The set of instructions may include an acquisition routine for acquiring medical imaging data. The medical imaging data may include a set of images. The set of images may have been generated from a medical diagnostic imaging system, such as an x-ray system, a computerized tomography (CT) system, an ultrasound system, an electron beam tomography (EBT) system, or a magnetic resonance (MR) system. It is contemplated that a set of images from other imaging systems may be retrieved. It is also contemplated the set of images is retrieved from memory, such as external memory or internal memory. In another example, the information associated with other data types, such as SOPs which may include images, structured reports, key image notes, or presentation states, may be acquired.

The set of instructions may optionally include a display routine for displaying the set of images. A user may manipulate the images, for example reviewing various images from the set of images. In an embodiment, the set of instructions may include a manual marking routine. The manual marking routine may allow a user may manually mark images to be archived while viewing the images. For example, if a user wishes to archive an image, but is not sure whether the archiving rules will select the image, the user may archive the image manually by selecting the image. In an embodiment, the manual selection works in addition to the archiving rules previously selected.

The set of instructions may include a comparison routine for comparing the information associated with the medical imaging data, such as a set of images, or other data type with the criteria. It is also contemplated, in an embodiment, the comparison routine compares the image data with the set of criteria. For example, the information associated with the set of images may be header information for the set of images or header information for individual images. The image data may describe the content of the images, such as the anatomical structure illustrated in the images. The set of instructions may include an archiving and discarding routine for archiving medical imaging data satisfying the criteria and discarding medical imaging data that does not satisfy the criteria.

Certain embodiments of the present invention provide a technical effect of selectively archiving data acquired by medical diagnostic imaging systems. Certain embodiments allow a user or other system to select criteria used to archive medical imaging data. Medical imaging data may include sets of images, individual images, or other types of data such as SOPs, structured reports, key image notes, or presentation states, for example. In such a manner, health care organizations may control which information is archived and which information is discarded according to their application and context.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for selectively archiving data acquired by medical diagnostic imaging systems, said system comprising:
a display unit for displaying medical data, said medical data having associated information;
an input unit for receiving input from a user, said input including criteria to selectively archive said medical data; and,
a computer unit for executing computer software, said computer software comparing said associated information with said criteria and archiving medical data having associated information that satisfies said criteria.

2. The system of claim 1, wherein said associated information is header information.

3. The system of claim 1, wherein said criteria includes criteria from an external system to selectively archive said medical data.

4. The system of claim 1, wherein said medical data includes medical images.

5. The system of claim 1, wherein the criteria includes one of the following:
modality, procedure code, institution, department, physician, data type, patient demographics.

6. The system of claim 1, wherein the criteria includes archiving a plurality of medical data until a more recent set of medical data is acquired for the patient.

7. The system of claim 1, wherein said input from a user includes input regarding manual selection of medical images for archiving.

8. The system of claim 1, wherein said criteria is image data.

9. The system of claim 8, wherein said image data is anatomical structures.

10. The system of claim 1, wherein said system is a picture archival communication system.

11. A method for selectively archiving medical imaging data, said method comprising:
receiving criteria to selectively archive medical imaging data;
acquiring medical imaging data, said medical imaging data having associated information;
comparing said associated information with said criteria; and,
archiving medical imaging data having associated information that satisfies said criteria and discarding medical imaging data having associated information that does not satisfy said criteria.

12. The method of claim 11, wherein said associated information is header information.

13. The method of claim 12, wherein the header information is for a plurality of medical images.

14. The method of claim 12, wherein the header information is for a single medical image.

15. The method of claim 11, wherein the criteria is received from a user.

16. The method of claim 11, wherein said criteria is image data.

17. The method of claim 11, wherein the criteria is received from an HIS/RIS system.

18. A computer-readable storage medium including a set of instructions for a computer, the set of instructions comprising:
a receipt routine for receiving criteria to selectively archive medical imaging data;
an acquisition routine for acquiring medical imaging data, said medical imaging data having associated information;
a comparison routine for comparing said associated information with said criteria; and,
an archiving and discarding routine for archiving medical imaging data having associated information that satisfies said criteria and discarding medical imaging data having associated information that does not satisfy said criteria.

19. The set of instructions of claim 18, further comprising a display routine for displaying said medical images represented by said medical imaging data after said medical imaging data is acquired and prior to comparing said associated information with said criteria.

20. The set of instructions of claim 19, further comprising a marking routine for manually marking medical imaging data for archiving.
